(19) United States
(12) Patent Application Publication
(10) Pub. No.: US 2024/0250281 A1
(43) Pub. Date: Jul. 25, 2024

(54) HYBRID RECYCLE FUEL CELL/ELECTROLYSIS SYSTEM FOR HIGH EFFICIENCY

(71) Applicant: VERSA POWER SYSTEMS LTD., Danbury, CT (US)

(72) Inventor: Casy Cloudless Brown, Calgary (CA)

(21) Appl. No.: 18/416,414

(22) Filed: Jan. 18, 2024

Related U.S. Application Data
(60) Provisional application No. 63/439,924, filed on Jan. 19, 2023.

(51) Int. Cl. H01M 8/249; C25B 1/04; C25B 9/77; C25B 15/08; H01M 8/04014; H01M 8/04119; H01M 8/0656; H01M 8/0662; H01M 8/12; H01M 8/2425

(52) U.S. Cl. CPC H01M 8/249; C25B 1/04; C25B 9/77; C25B 15/083; H01M 8/04022; H01M 8/04156; H01M 8/0656; H01M 8/0662; H01M 8/2425; H01M 2008/1293

(57) ABSTRACT

A solid oxide fuel cell system includes a first fuel cell stack including a first anode section and a first cathode section. The first anode section is configured to receive an input stream including fuel, and to output a first output stream including residual fuel and water. A second fuel cell stack includes a second anode section and a second cathode section. The second anode section is configured to receive a mixed stream and to output a second output stream including residual fuel and water. Each of the first and second cathode section is configured to receive inlet air and to output exhaust air. A separating junction is configured to receive and separate the second output stream into a recycle stream and an exhaust stream. A combining junction is configured to receive the first output stream and the recycle stream, and to combine these streams to output the mixed stream.

### CROSS-REFERENCE TO RELATED APPLICATION

This application claims the benefit of and priority to U.S. Provisional Patent Application No. 63/439,924, filed Jan. 19, 2023, which is incorporated by reference herein in its entirety.

### BACKGROUND

The present disclosure relates generally to the field of electrochemical cells, such as fuel cells and electrolyzer cells, and more particularly to fuel cell systems with exhaust recycle systems or cascaded fuel cell stacks.

Generally, a fuel cell includes an anode, a cathode, and an electrolyte layer that together drive chemical reactions to produce electricity. Fuel cells may also be operated as electrolysis cells to produce hydrogen. Multiple fuel cells may be arranged in a fuel cell stack to produce the desired amount of electricity or hydrogen. In a fuel cell mode, fuel, such as hydrogen gas or hydrocarbon gas, is supplied to the anode while oxidant is supplied to the cathode. The fuel and oxidant are consumed by the electrochemical reactions as they flow over the anode and cathode. Ions cross an electrolyte from the anode to the cathode or from the cathode to the anode, while electrons travel through an external circuit, generating an electrical current. In a solid oxide fuel cell, oxygen ions cross the electrolyte from the cathode to the anode. In electrolysis mode, water, in the form of steam, and power are supplied to the cathode. The water and power are consumed by the electrochemical reactions as the water flows over the cathode, producing hydrogen at the cathode and oxygen at the anode.

To increase the efficiency of fuel cell systems, residual fuel from the outlet of the fuel cell stack may be recycled to the inlet of the fuel cell stack, or residual fuel from the outlet of the fuel cell stack may be directed or “cascaded” to the inlet of another fuel cell stack. These strategies provide enhanced efficiency by reacting a higher proportion of the fuel, thus reducing the amount of fresh fuel that must be supplied to the system. Similar strategies can provide efficiency improvements in electrolysis mode.

While these methods improve overall efficiency, there are some drawbacks to these. First, the outlet stream is diluted by the products of reaction, which may reduce fuel cell performance when the outlet stream is recycled or cascaded to another fuel cell stack. Second, the flows internal to the system become larger, sometimes significantly larger, as more products of reaction are circulated along with reactants. These higher flows can drive cost and complexity into piping, recycle blowers, heat exchangers, and if used, condensers.

### SUMMARY

Certain embodiments of the present disclosure may address the above-described problems with previous fuel cell systems.

In some embodiments, a solid oxide fuel cell system includes a first fuel cell stack including a first anode section and a first cathode section, the first anode section configured to receive an input stream including fuel, and to output a first output stream including residual fuel and water, the first cathode section configured to receive inlet air and to output exhaust air. The solid oxide fuel cell system also includes a second fuel cell stack including a second anode section and a second cathode section, the second anode section configured to receive a mixed stream and to output a second output stream including residual fuel and water, the second cathode section configured to receive inlet air and to output exhaust air. The solid oxide fuel cell system also includes a separating junction configured to receive the second output stream and to separate the second output stream into a recycle stream and an exhaust stream. The solid oxide fuel cell system also includes a combining junction configured to receive the first output stream and the recycle stream, and to combine the first output stream and the recycle stream to output the mixed stream.

In some embodiments, a solid oxide fuel cell system operated as a solid oxide electrolysis cell system includes a first fuel cell stack including a first anode section and a first cathode section, the first cathode section configured to receive an input stream including water, and to output a first output stream including residual water and hydrogen, the first anode section configured to output exhaust air. The solid oxide fuel cell system also includes a second fuel cell stack including a second anode section and a second cathode section, the second cathode section configured to receive a mixed stream and to output a second output stream including residual water and hydrogen, the second anode section configured to output exhaust air. The solid oxide fuel cell system also includes a separating junction configured to receive the second output stream and to separate the second output stream into a recycle stream and an exhaust stream. The solid oxide fuel cell system also includes a combining junction configured to receive the first output stream and the recycle stream, and to combine the first output stream and the recycle stream to output the mixed stream.

In some embodiments, a solid oxide fuel cell system includes a first fuel cell stack including a first anode section and a first cathode section, the first anode section configured to receive an input stream including fuel, and to output a first output stream including residual fuel and water, the first cathode section configured to receive inlet air and to output exhaust air. The solid oxide fuel cell system also includes a second fuel cell stack including a second anode section and a second cathode section, the second anode section configured to receive a mixed stream and to output a second output stream including residual fuel and water, the second cathode section configured to receive inlet air and to output exhaust air. The solid oxide fuel cell system also includes a junction configured to receive the first output stream and the second output stream and to output the mixed stream and an exhaust stream

In some embodiments, a solid oxide fuel cell system operated as a solid oxide electrolysis cell system, the solid oxide fuel cell system includes a first fuel cell stack including a first anode section and a first cathode section, the first cathode section configured to receive an input stream including water and to output a first output stream including residual water and hydrogen, the first anode section configured to output exhaust air. The solid oxide fuel cell system also includes a second fuel cell stack including a second anode section and a second cathode section, the second cathode section configured to receive a mixed stream and to output a second output stream including residual water and hydrogen, the second anode section configured to output exhaust air. The solid oxide fuel cell system also includes a junction configured to receive the first output stream and the second output stream and to output the mixed stream and an exhaust stream.

In some embodiments, a method of operating a solid oxide fuel cell system in a fuel cell mode includes providing an input stream including fuel to a first anode section of a first fuel cell stack. The method also includes directing a first output stream including residual fuel and water from the first anode section of the first fuel cell stack to a combining junction. The method also includes directing a mixed stream from the combining junction to a second anode section of a second fuel cell stack. The method also includes directing a second output stream including residual fuel and water from the second anode section of the second fuel cell stack to a separating junction. The method also includes separating the second output stream into a recycle stream and an exhaust stream at the separating junction. The method also includes combining the recycle stream and the first output stream into the mixed stream at the combining junction.

In some embodiments, a method of operating a solid oxide fuel cell system in an electrolysis mode includes providing an input stream including water to a first cathode section of a first fuel cell stack. The method also includes directing a first output stream including residual water and hydrogen from the first cathode section of the first fuel cell stack to a combining junction. The method also includes directing a mixed stream from the combining junction to a second cathode section of a second fuel cell stack. The method also includes directing a second output stream including residual water and hydrogen from the second cathode section of the second fuel cell stack to a separating junction. The method also includes separating the second output stream into a recycle stream and an exhaust stream at the separating junction. The method also includes combining the recycle stream and the first output stream into the mixed stream at the combining junction.

In some embodiments, a method of operating a solid oxide fuel cell system in a fuel cell mode includes providing an input stream including fuel to a first anode section of a first fuel cell stack. The method also includes directing a first output stream including residual fuel and water from the first anode section of the first fuel cell stack to a junction. The method also includes directing a mixed stream from the junction to a second anode section of a second fuel cell stack. The method also includes directing a second output stream including residual fuel and water from the second anode section of the second fuel cell stack to the junction. The method also includes combining the first output stream and the second output stream into the mixed stream at the junction.

In some embodiments, a method of operating a solid oxide fuel cell system in an electrolysis mode includes providing an input stream including water to a first cathode section of a first fuel cell stack. The method also includes directing a first output stream including residual water and hydrogen from the first cathode section of the first fuel cell stack to a junction. The method also includes directing a mixed stream from the junction to a second cathode section of a second fuel cell stack. The method also includes directing a second output stream including residual water and hydrogen from the second cathode section of the second fuel cell stack to the junction. The method also includes combining the first output stream and the second output stream into the mixed stream at the junction.

In some embodiments, a method of operating a solid oxide fuel cell system includes operating the solid oxide fuel cell system in fuel cell mode. Operating in fuel cell mode includes providing an input stream including fuel to a first anode section of a first fuel cell stack, directing a first output stream including residual fuel and water from the first anode section of the first fuel cell stack to a combining junction, directing a mixed stream from the combining junction to a second anode section of a second fuel cell stack, directing a second output stream including residual fuel and water from the second anode section of the second fuel cell stack to a separating junction, separating the second output stream into a recycle stream and an exhaust stream at the separating junction, and combining the recycle stream and the first output stream into the mixed stream at the combining junction. The method of operating the solid oxide fuel cell system includes operating the solid oxide fuel cell system in electrolysis mode. Operating in electrolysis mode includes providing a second input stream including water to the first anode section, the first anode section configured to operate as a cathode, directing a third output stream including residual water and hydrogen from the first anode section to the combining junction, directing a second mixed stream from the combining junction to the second anode section, the first anode section configured to operate as a cathode, directing a fourth output stream including residual water and hydrogen from the second anode section to the separating junction, separating the fourth output stream into a second recycle stream and a second exhaust stream at the separating junction, and combining the second recycle stream and the third output stream into the second mixed stream at the combining junction.

### BRIEF DESCRIPTION OF THE DRAWINGS

FIG. 1 is a diagram of a baseline recycle solid oxide fuel cell system.

FIG. 2 is a simulation model of a baseline recycle solid oxide fuel cell system.

FIG. 3 is a simulation model of a compression dryer of the baseline recycle solid oxide fuel cell system of FIG. 2.

FIG. 4 is a diagram of a baseline cascaded solid oxide fuel cell system.

FIG. 5 is a diagram of a hybrid solid oxide fuel cell system, according to an embodiment.

FIG. 6 is a diagram of the hybrid fuel cell system of FIG. 5, operated as a solid oxide electrolysis system, according to an embodiment.

FIG. 7 is a simulation model of a hybrid solid oxide fuel cell system, according to an embodiment.

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

To improve the efficiency of fuel cell systems, it may be desirable to increase the proportion of fuel or water that is reacted. However, the efficiency gains in traditional fuel cell systems with anode recycle streams or cascaded fuel cell stacks are limited due to the products of reaction in the anode outlet streams, which dilute the fuel and increase the total volume of gas in the outlet stream. Traditional systems may need larger and more complicated piping, recycle blowers, heat exchangers, and condensers to deal with the volume of gas in the outlet stream. The fuel cell systems disclosed herein may include a first fuel cell stack cascaded to a second fuel cell stack. The systems may include an anode recycle loop that recycles only the outlet stream from the second fuel cell stack. The anode recycle stream, as well as the anode output from the first fuel cell stack may pass through a water knockout stage to reduce the volume of gas being supplied to the second fuel cell stack and the recycle blower.

Various embodiments of the fuel cell systems described herein may provide one or more advantages, including, for example: (1) for a given overall efficiency of a fuel cell system, allowing for a smaller recycle system, reduced water knockout requirements, reduced pressure drop, and/or less complexity than a fuel cell system with multiple stages of cascading; (2) increasing overall efficiency of a fuel cell system; and (3) providing more favorable conditions at a first stage by directing fuel or water initially into the fuel cell stack without recycling.

### Baseline Fuel Cell Systems

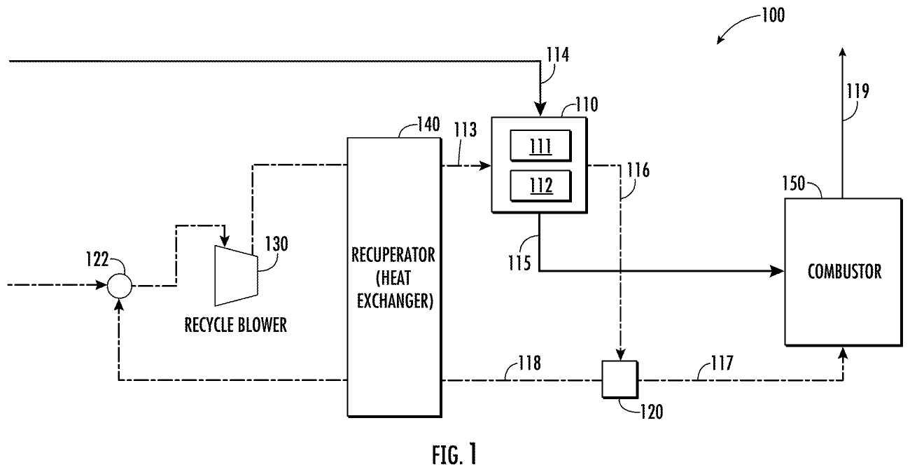

FIG. 1 depicts a baseline recycle solid oxide fuel cell (SOFC) system 100. The baseline recycle SOFC system 100 includes a fuel cell stack 110, a separating junction 120, a combining junction 122, a recycle blower 130, a recuperator 140, and a combustor 150.

The fuel cell stack 110 includes an anode section 111 and a cathode section 112. The anode section 111 of the fuel cell stack 110 is configured to receive a mixed stream 113. The mixed stream 113 includes a fuel that may include a hydrogen gas, a hydrocarbon fuel, or other suitable fuel. The cathode section 112 of the fuel cell stack 110 is configured to receive inlet air 114 having oxygen (e.g., an oxidant). The fuel cell stack 110 is configured to produce electricity when the anode section 111 of the fuel cell stack 110 reacts with the fuel of the mixed stream 113 and the cathode section 112 of the fuel cell stack 110 reacts with oxygen of the inlet air 114. The cathode section 112 of the fuel cell stack 110 is configured to output exhaust air 115. The anode section 111 of the fuel cell stack 110 is configured to output an output stream 116 having residual fuel and water.

The baseline recycle SOFC system 100 includes a separating junction 120 configured to receive the output stream 116 from the anode section 111 of the fuel cell stack 110. The separating junction 120 is configured to separate the output stream 116 into an exhaust stream 117 and a recycle stream 118.

The baseline recycle SOFC system 100 includes a combining junction 122 configured to combine the recycle stream 118 from the separating junction 120 with an input stream. The combining junction 122 is configured to output the mixed stream 113.

The baseline recycle SOFC system 100 includes a recycle blower 130 configured to receive the mixed stream 113 from the combining junction 122, to pressurize the mixed stream 113, and to output the mixed stream.

The baseline recycle SOFC system 100 includes a recuperator 140 (e.g., heat exchanger) configured to receive the recycle stream from the separating junction 120 and to output the recycle stream 118 to the combining junction 122. The recuperator 140 is configured to receive the mixed stream from the recycle blower 130 and to output the mixed stream to the anode section 111 of the fuel cell stack 110. The recuperator 140 is configured to transfer heat from the recycle stream 118 to the mixed stream 113.

The baseline recycle SOFC system 100 includes a combustor 150 configured to receive the exhaust air 115 from the cathode section 112 of the fuel cell stack 110 and the exhaust stream 117 from the separating junction 120. The combustor 150 is configured to combust the exhaust stream 117 and to output a combusted stream 119.

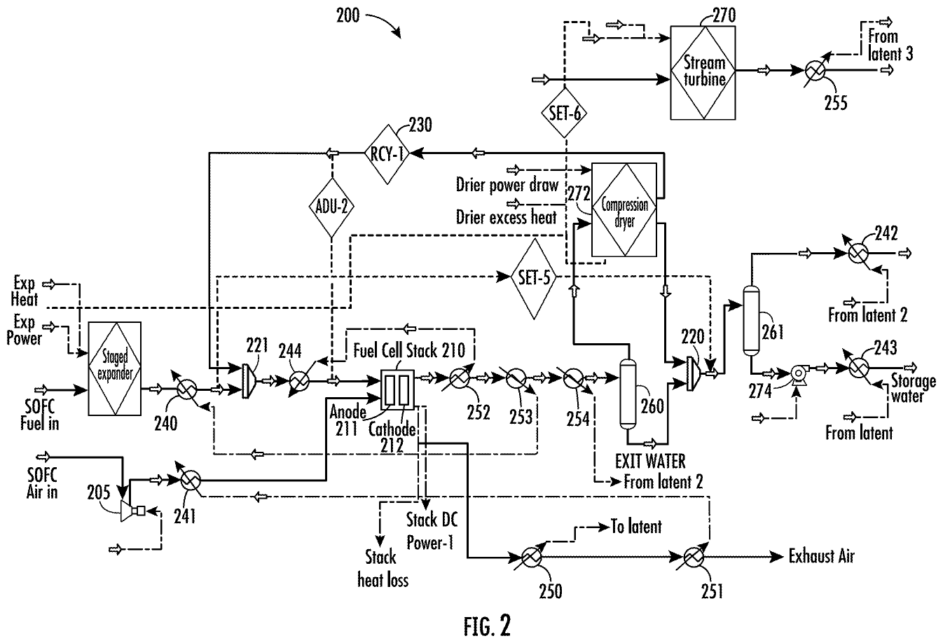

FIG. 2 depicts a simulation model of a baseline recycle SOFC system 200. The baseline recycle SOFC system 200 is an implementation of the baseline recycle SOFC system 100 shown in FIG. 1 and is configured for operation in a fuel cell mode.

The baseline recycle SOFC system 200 includes a staged expander 202 configured to receive the input stream having the fuel, to reduce the pressure of the input stream, and to output the input stream to the first heater 240 (e.g., a heat exchanger).

The baseline recycle SOFC system 200 includes a first heater 240 configured to receive the input stream, to heat the input stream, and to output the input stream to the second mixer 221. The first heater 240 is configured to receive heat from the fourth cooler 253 (e.g., a heat exchanger).

The baseline recycle SOFC system 200 includes a first compressor 205 configured to receive inlet air having oxygen, to pressurize the inlet air, and to output the inlet air to the second heater 241.

The baseline recycle SOFC system 200 includes a second heater 241 configured to receive the inlet air, to heat the inlet air, and to output the inlet air to the cathode section 212 of the fuel cell stack 210. The second heater 241 is configured to receive heat from the second cooler 251.

The baseline recycle SOFC system 200 includes a fuel cell stack 210 having an anode section 211 and a cathode section 212. The anode section 211 is configured to receive the mixed stream from the third heater 242. The cathode section 212 is configured to receive the inlet air from the second heater 241. The fuel cell stack 210 is configured to produce electricity when the anode section 211 reacts with the fuel of the mixed stream and the cathode section 212 reacts with oxygen of the inlet air. The anode section 211 of the fuel cell stack 210 is configured to output an output stream having residual fuel and water to the third cooler 252. The cathode section 212 is configured to output an exhaust air stream to the first cooler 250.

The baseline recycle SOFC system 200 includes a first cooler 250 configured to receive the exhaust air stream from the cathode section 212 of the fuel cell stack 210, to cool the exhaust air stream, and to output the exhaust air stream to the second cooler 251. The first cooler 250 is configured to output heat to the fourth heater 243.

The baseline recycle SOFC system 200 includes a second cooler 251 configured to receive the exhaust air stream from the first cooler 250, to cool the exhaust air stream, and to output the exhaust air stream out of the baseline recycle SOFC system 200. The second cooler 251 is configured to output heat to the second heater 241.

The baseline recycle SOFC system 200 includes a third cooler 252 configured to receive the output stream from the anode section 211 of the fuel cell stack 210, to cool the output stream, and to output the output stream to the fourth cooler 253. The third cooler 252 is configured to output heat to the third heater 242.

The baseline recycle SOFC system 200 includes a fourth cooler 253 configured to receive the output stream from the third cooler 252, to cool the output stream, and to output the output stream to the fifth cooler 254. The fourth cooler 253 is configured to output heat to the first heater 240.

The baseline recycle SOFC system 200 includes a fifth cooler 254 to receive the output stream from the fourth cooler 253, to cool the output stream, and to output the output stream to the first water knockout pot 260. The fifth cooler 254 is configured to output heat to the third heater 242.

The baseline recycle SOFC system 200 includes a first water knockout pot 260 configured to receive the output stream from the fifth cooler 254, to remove water from the output stream and to output water to the first mixer 220, and to output the output stream to the compression dryer 272.

The baseline recycle SOFC system 200 includes a compression dryer 272 configured to receive the output stream from the first water knockout pot 260, to remove water from the output stream and to output water to the first mixer 220, and to output the output stream to the recycle blower 230.

The baseline recycle SOFC system 200 includes a first mixer 220 configured to receive water from the first water knockout pot 260 and to receive water from the compression dryer 272, and to output water to the second water knockout pot 261.

The baseline recycle SOFC system 200 includes a second water knockout pot 261 configured to receive water from the first mixer 220, to output a second output stream to a third heater 242, and to output water to a pump 274.

The baseline recycle SOFC system 200 includes a third heater 242 that is included in the model to represent unrecoverable heat loss from the water knockout.

The baseline recycle SOFC system 200 includes a pump 274 configured to receive water from the second water knockout pot 261, and to output water to the fourth heater 243.

The baseline recycle SOFC system 200 includes a fourth heater 243 configured to receive water from the pump 274, to heat the water, and to output heated water for storage. The fourth heater 243 is configured to receive heat from the first cooler 250.

The baseline recycle SOFC system 200 includes a recycle blower 230 configured to receive the output stream from the compression dryer 272, to pressurize the output stream, and to output the output stream to the second mixer 221.

The baseline recycle SOFC system 200 includes a second mixer 221 configured to receive the output stream from the recycle blower 230, to receive the input stream from the first heater 240, and to output the mixed stream to the third heater 242.

The baseline recycle SOFC system 200 includes a third heater 242 configured to receive the mixed stream from the second mixer 221, to heat the mixed stream, and to output the mixed stream to the anode section 211 of the fuel cell stack 210. The third heater 242 is configured to receive heat from the third cooler 252.

The settings for the simulation model of the baseline recycle SOFC system 200 allow a user to adjust the amount of the output stream configured to be output by the recycle blower 230 to match the desired amount of the mixed stream configured to be received by the anode section 211 of the fuel cell stack 210.

The settings for the simulation model of the baseline recycle SOFC system 200 also allow the user to set the amount of water configured to be output by the first mixer 220 based on the amount of the input stream configured to be received by the second mixer 221.

The baseline recycle SOFC system 200 includes a steam turbine 270 configured to boil water using waste heat from the system 200 to spin a turbine to generate additional power.

The baseline recycle SOFC system 200 includes a sixth cooler 255 configured to receive water from the steam turbine 270, to cool water, and to output water. The sixth cooler 255 is configured to output heat for latent heat storage.

The settings for the simulation model of the baseline recycle SOFC system 200 also allow the user to set the amount of heat configured to be received by the steam turbine 270 based on the amount of the drier excess heat configured to be received by the compression dryer 272.

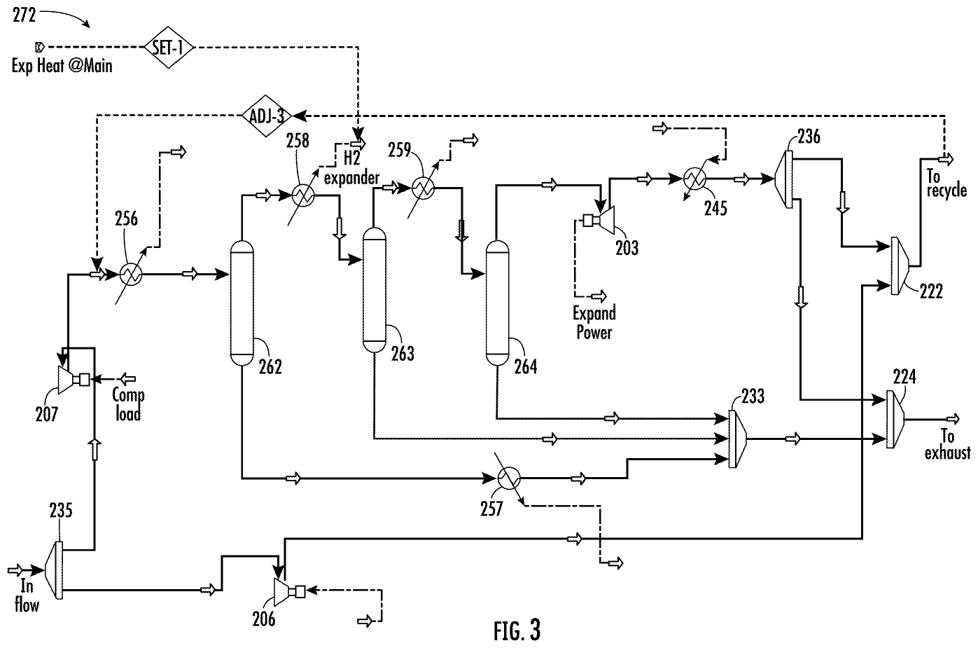

FIG. 3 depicts a simulation model of the compression dryer 272 of the baseline recycle SOFC system 200.

The compression dryer 272 includes a first splitter 235 configured to receive the output stream from the first water knockout pot 260, to separate the output stream into an output stream first portion and an output stream second portion, to output the output stream first portion to the third compressor 207, and to output the output stream second portion to the second compressor 206.

The compression dryer 272 includes a second compressor 206 configured to receive the output stream second portion from the first splitter 235, to compress the output stream second portion, and to output the output stream second portion to a third mixer 222.

The compression dryer 272 includes a third mixer 222 configured to receive the output stream second portion from the second compressor 206, to receive the output stream first portion from the second splitter 236, to combine the output stream first portion and the output stream second portion into the output stream, and to output the output stream to the recycle blower 230.

The compression dryer 272 includes a third compressor 207 configured to receive the output stream first portion from the first splitter 235, to compress the output stream first portion, and to output the output stream first portion to the seventh cooler 256.

The compression dryer 272 includes a seventh cooler 256 configured to receive the output stream first portion from the third compressor 207, to cool the output stream first portion, and to output the output stream first portion to the third water knockout pot 262.

The compression dryer 272 includes a third water knockout pot 262 configured to receive the output stream first portion from the seventh cooler 256, to remove water from the output stream first portion and to output water to the eighth cooler 257, and to output the output stream first portion to the ninth cooler 258.

The compression dryer 272 includes an eighth cooler 257 configured to receive water from the third water knockout pot 262, to cool water, and to output water to the fourth mixer 223.

The compression dryer 272 includes a fourth mixer 223 configured to receive water from the eighth cooler 257, to receive water from the fourth water knockout pot 263, to receive water from the fifth water knockout pot 264, and to output water to the fifth mixer 224.

The compression dryer 272 includes a fifth mixer 224 configured to receive water from the fourth mixer 223, to receive an output stream third portion from the second splitter 236, and to output water and the output stream third portion to the first mixer 220.

The compression dryer 272 includes a ninth cooler 258 configured to receive the output stream first portion from the third water knockout pot 262, to cool the output stream first portion, and to output the output stream first portion to the fourth water knockout pot 263. The ninth cooler 258 is configured to output heat to a H₂ expander.

The settings for the simulation model of the compression dryer 272 allow the user to set the amount of heat configured to be output by the ninth cooler 258 based on the amount of __.

The compression dryer 272 includes a fourth water knockout pot 263 configured to receive the output stream first portion from the ninth cooler 258, to remove water from the output stream first portion and to output water to the fourth mixer 223, and to output the output stream first portion to the tenth cooler 259.

The compression dryer 272 includes a tenth cooler 259 configured to receive the output stream first portion from the fourth water knockout pot 263, to cool the output stream first portion, and to output the output stream portion to the fifth water knockout pot 264.

The compression dryer 272 includes a fifth water knockout pot 264 configured to receive the output stream first portion from the tenth cooler 259, to remove water from the output stream first portion and to output water to the fourth mixer 223, and to output the output stream first portion to the expander 203.

The compression dryer 272 includes an expander 203 configured to receive the output stream first portion from the fifth water knockout pot 264, to compress the output stream first portion, and to output the output stream first portion to the sixth heater 245.

The compression dryer 272 includes a sixth heater 245 configured to receive the output stream first portion, to heat the output stream first portion, and to output the output stream first portion to the second splitter 236.

The compression dryer 272 includes a second splitter 236 configured to receive the output stream first portion from the sixth heater 245, to split an output stream third portion from the output stream first portion, to output the combined output stream third portion to the fifth mixer 224, and to output the output stream first portion to the third mixer 222.

The settings for the simulation model of the compression dryer 272 also allow the user to adjust the amount of the output stream first portion configured to be received by the seventh cooler 256 to match the desired amount of the output stream first portion that is configured to be output by the third mixer 222.

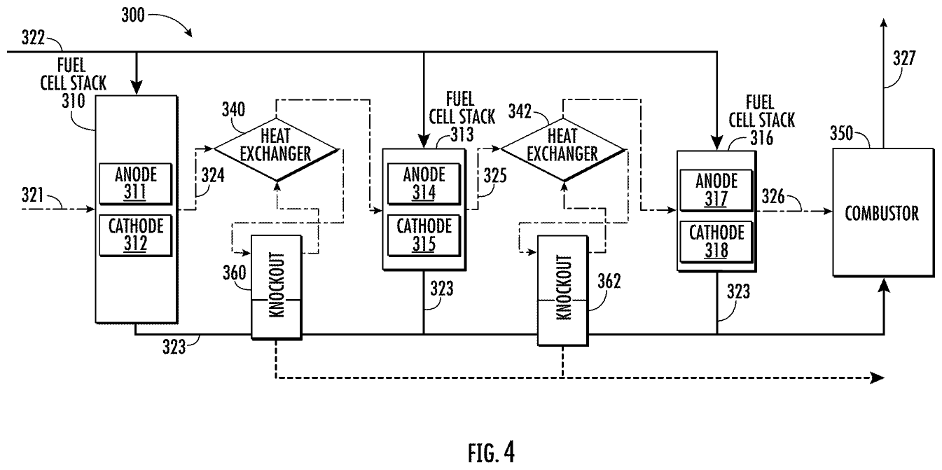

FIG. 4 depicts a baseline cascaded SOFC system 300. The baseline cascaded SOFC system 300 includes a first fuel cell stack 310, a second fuel cell stack 313, a third fuel cell stack 316, a first recuperator 340, a second recuperator 342, a first water knockout pot 360, a second water knockout pot 362, and a combustor 350.

The baseline cascaded SOFC system 300 includes a first fuel cell stack 310. The first fuel cell stack 310 includes a first anode section 311 and a first cathode section 312. The first anode section 311 of the first fuel cell stack 310 is configured to receive an input stream 321. The input stream has a fuel that may include a hydrogen gas, a hydrocarbon fuel, or other suitable fuel. The first cathode section 312 of the first fuel cell stack 310 is configured to receive inlet air 322 having oxygen. The first fuel cell stack 310 is configured to produce electricity when the first anode section 311 of the first fuel cell stack 310 reacts with the fuel of the input stream and the first cathode section 312 of the first fuel cell stack 310 reacts with oxygen of the inlet air. The first cathode section 312 of the first fuel cell stack 310 is configured to output exhaust air 323. The first anode section 311 of the first fuel cell stack 310 is configured to output a first output stream 324 having residual fuel and water.

The baseline cascaded SOFC system 300 includes a first recuperator 340 (e.g., heat exchanger) configured to receive the first output stream 324 from the first fuel cell stack 310 and to output the first output stream 324 to the first water knockout pot 360. The first recuperator 340 is configured to receive the first output stream 324 from the first water knockout pot 360 and to output the first output stream 324 to the second anode section 314 of the second fuel cell stack 313. The first recuperator 340 is configured to transfer heat from the first output stream 324 before reaching the first water knockout pot 360 to the first output stream 324 after leaving the first water knockout pot 360.

The baseline cascaded SOFC system 300 includes a first water knockout pot 360 configured to receive the first output stream 324 from the first recuperator 340, to remove water from the first output stream 324, and to output the first output stream 324 to the first recuperator 340.

The baseline cascaded SOFC system 300 includes a second fuel cell stack 313. The second fuel cell stack 313 includes a second anode section 314 and a second cathode section 315. The second anode section 314 of the second fuel cell stack 313 is configured to receive the first output stream 324. The second cathode section 315 of the second fuel cell stack 313 is configured to receive inlet air 322 having oxygen. The second fuel cell stack 313 is configured to produce electricity when the second anode section 314 of the second fuel cell stack 313 reacts with the fuel of the first output stream 324 and the second cathode section 315 of the second fuel cell stack 313 reacts with oxygen of the inlet air 322. The second cathode section 315 of the second fuel cell stack 313 is configured to output exhaust air 323. The second anode section 314 of the second fuel cell stack 313 is configured to output a second output stream 325 having residual fuel and water.

The baseline cascaded SOFC system 300 includes a second recuperator 343 (e.g., heat exchanger) configured to receive the second output stream 325 from the second anode section 314 of the second fuel cell stack 313 and to output the second output stream 325 to the second water knockout pot 362. The second recuperator 342 is configured to receive the second output stream 325 from the second water knockout pot 362 and to output the second output stream 325 to the third anode section 317 of the third fuel cell stack 316. The second recuperator 342 is configured to transfer heat from the second output stream 325 before reaching the second water knockout pot 362 to the second output stream 325 after leaving the second water knockout pot 362.

The baseline cascaded SOFC system 300 includes a second water knockout pot 362 configured to receive the second output stream 325 from the second recuperator 342, to remove water from the second output stream 325, and to output the second output stream 325 to the second recuperator 342.

The baseline cascaded SOFC system 300 includes a third fuel cell stack 316. The third fuel cell stack 316 includes a third anode section 317 and a third cathode section 318. The third anode section 317 of the third fuel cell stack 316 is configured to receive the second output stream 325. The third cathode section 318 of the third fuel cell stack 316 is configured to receive inlet air 322 having oxygen. The third fuel cell stack 316 is configured to produce electricity when the third anode section 317 of the third fuel cell stack 316 reacts with the fuel of the second output stream 325 and the third cathode section 318 of the third fuel cell stack 316 reacts with oxygen of the inlet air 322. The third cathode section 318 of the third fuel cell stack 316 is configured to output exhaust air 323. The third anode section 317 of the third fuel cell stack 316 is configured to output an exhaust stream 326 having residual fuel and water.

The baseline cascaded SOFC system 300 includes a combustor 350 configured to receive the exhaust air 323 from the first cathode section 312 of the first fuel cell stack 310, the exhaust air 323 from the second cathode section 315 of the second fuel cell stack 313, the exhaust air 323 from the third cathode section 318 of the third fuel cell stack 316, and the exhaust stream 326 from the third anode section 317 of the third fuel cell stack 316. The combustor 350 is configured to combust the exhaust stream 326 and to output a combusted stream 327.

### Hybrid Fuel Cell System

As compared to the baseline recycle SOFC system 100 and the baseline cascaded SOFC system 300, which employ one of either a recycle design or a cascaded design, a hybrid fuel cell system, according to some embodiments, may be a cascaded system with a second reversible fuel cell positioned downstream of a first reversible fuel cell and including a recycle stream that recycles unused fuel from the second anode outlet bac to the second anode inlet. This arrangement allows for the hybrid fuel cell system to have smaller and simpler water separation needs as compared to baseline fuel cell systems, which results in improved efficiency as well as lower system equipment cost and complexity. Further, this arrangement provides the benefits of a first stage of a cascaded fuel cell system in which the reactant concentrations entering the first stage of the cascaded fuel cell system are undiluted and more favorable (as compared to downstream stages of the cascaded fuel cell system), as well as the benefits a recycle fuel cell system. Furthermore, recycling the anode exhaust from the downstream stage back to the anode inlet of the downstream stage allows for reduced recycle blower and recuperation requirements (as compared to baseline fuel cell systems), which allow for a 2× to 5× reduction in recycle flow while simultaneously offering more favorable inlet reactant compositions as compared to baseline fuel cell systems. As compared to the baseline cascaded fuel cell system, the hybrid fuel cell system can achieve the same efficiency levels with fewer stages, which reduces flow management complexity, reduces associated pressure differences across the stages, reduces the number of water knockout pots needed, and allows for increased equilibrium humidity without impacting overall efficiency.

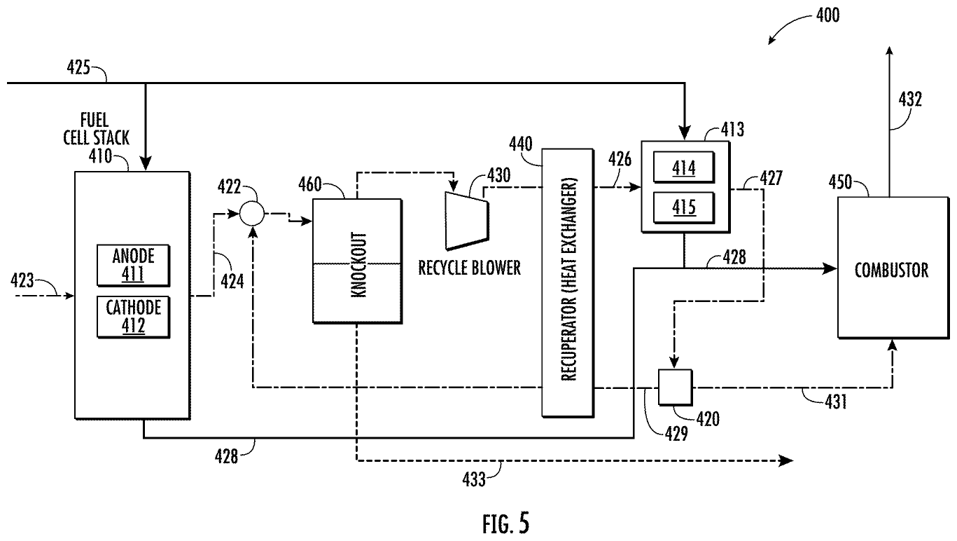

FIG. 5 depicts a hybrid SOFC system 400. The hybrid SOFC system 400 may be a reversible SOFC system configured to operate in either a fuel cell mode or an electrolysis mode. The hybrid SOFC system 400 will first be described when configured to operate in the fuel cell mode, and will then be described when configured to operate in the electrolysis mode.

The hybrid solid oxide fuel cell (SOFC) system 400 includes a first fuel cell stack 410 including a first anode section 411 and a first cathode section 412, the first anode section 411 configured to receive an input stream 423 including fuel (e.g., hydrogen gas, a hydrocarbon fuel, other suitable fuel, etc.) and to output a first output stream 424 including residual fuel and water. The first cathode section 412 is configured to receive inlet air 425 (e.g., oxidant) and to output exhaust air 428. The hybrid SOFC system 400 also includes a second fuel cell stack 413 including a second anode section 414 and a second cathode section 415, the second anode section 414 configured to receive a mixed stream 426 and to output a second output stream 427 including residual fuel and water. The second cathode section 415 is configured to receive inlet air 425 (e.g., oxidant) and to output exhaust air 428. The hybrid SOFC system 400 also includes a separating junction 420 configured to receive the second output stream 427 and to separate the second output stream into a recycle stream 429 and an exhaust stream 431. The hybrid SOFC system 400 also includes a combining junction 422 configured to receive the first output stream 424 and the recycle stream 429, and to combine the first output stream 424 and the recycle stream 429 to output the mixed stream 426. In some embodiments, the hybrid SOFC system 400 may include a recycle blower 430, a recuperator 440 (e.g., a heat exchanger), a combustor 450, and/or a water knockout pot 460.

The first fuel cell stack 410 is configured to produce electricity when fuel in the first anode section 411 reacts with oxidant in the first cathode section. The first anode section 411 of the first fuel cell stack 410 is configured to output the first output stream 424 having residual fuel and water generated during the fuel cell reactions. The first cathode section 412 of the first fuel cell stack 410 is configured to output exhaust air 428. The first output stream 424 from the first anode section 411 is directed to a combining junction 422, where it is combined with the recycle stream 429 from the second anode section 414. In FIG. 5, the combining junction 422 is configured to receive the recycle stream 429 from the recuperator 440 and to output the mixed stream 426 to the water knockout pot 460.

The hybrid SOFC system 400 may include a water knockout pot 460 configured to receive the mixed stream 426, to remove water from the mixed stream (via water stream 433), and to output a dried mixed stream 426. In the embodiment shown in FIG. 5, the water knockout pot 460 is configured to receive the mixed stream 426 from the combining junction 422 and to output the dried mixed stream 426 to the recycle blower 430. The recycle blower 430 may be configured to receive the dried mixed stream 426 from the water knockout pot, to pressurize the dried mixed stream 426, and to output the mixed stream 426. The dried and pressurized mixed stream 426 may output to the recuperator 440. Heat from the recycle stream 429 may be transferred to the dried and pressurized mixed stream 426 in the recuperator 440 and output as a dried, pressurized, and heated mixed stream 426.

The hybrid SOFC system 400 includes a second fuel cell stack 413. The second fuel cell stack 413 includes a second anode section 414 and a second cathode section 415. The second anode section 414 of the second fuel cell stack 413 is configured to receive the mixed stream 426 (e.g., the dried, pressurized, and heated mixed stream 426 from the recuperator 440). The second cathode section 415 of the second fuel cell stack 413 is configured to receive inlet air 425 (e.g., oxidant) including oxygen. The second fuel cell stack 413 is configured to produce electricity when the fuel in the second anode section 414 reacts with oxygen in the inlet air 425 in the second cathode section 415. The second cathode section 415 of the second fuel cell stack 413 is configured to output exhaust air 428. The second anode section 414 of the second fuel cell stack 413 is configured to output a second output stream 427 having residual fuel and water.

The hybrid SOFC system 400 includes a separating junction 420 configured to receive the second output stream 427, to separate the second output stream 427 into an exhaust stream 431 and a recycle stream 429, and to output the exhaust stream 431 and the recycle stream 429. In the embodiment shown in FIG. 5, the separating junction 420 is configured to output the recycle stream 429 to the recuperator 440 and to output the exhaust stream 431 to the combustor 450. Heat from the recycle stream 429 may be transferred to the mixed stream 426 (e.g., the dried and pressurized mixed stream) in the recuperator 440.

The hybrid SOFC system 400 may include a combustor 450 configured to receive the exhaust air 428 from the first cathode section 412 of the first fuel cell stack 410, the exhaust air 428 from the second cathode section 415 of the second fuel cell stack 413, and the exhaust stream 431 from the separating junction 420. The combustor 450 is configured to combust the exhaust stream 431 and to output a combusted stream 432.

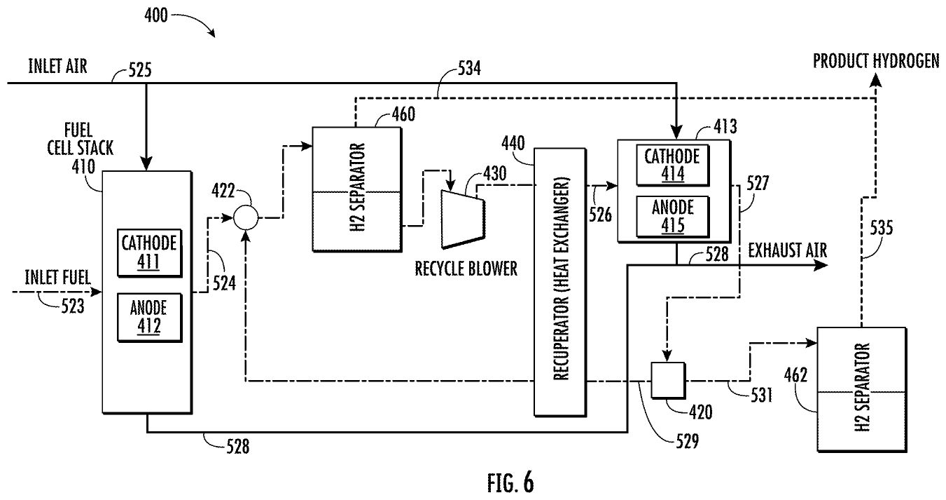

FIG. 6 illustrates the hybrid SOFC system 400 configured to operate as a solid oxide electrolysis system, according to some embodiments. In electrolysis mode, the anode sections 411, 414 of the SOFC system 400 operate as cathode sections and the cathode sections 412, 415 of the SOFC system 400 operate as anode sections. When the SOFC system 400 is described herein as operating as an electrolysis system, the first and second anode sections 411, 414 are referred to as the first and second cathode sections 411, 414, and the first and second cathode sections 412, 415 of the SOFC system 400 are referred to as the first and second anode sections 412, 415. It should be understood that the use of the terms anode section and cathode section below to describe the function of the electrodes and therefore reflects a difference in terminology, rather than a difference in the structure of the SOFC system 400. Thus, the SOFC system 400 may be operated in both fuel cell mode and electrolysis mode with only minor changes in the system gas flows. The outlet of the first anode section 411 in the SOFC system 400 remains coupled to the inlet of the second anode section 414 despite their being respectively referred to as the first cathode section 411 and the second cathode section 414 when electrolysis mode is described. The anode sections 411, 414 in fuel cell mode (i.e., the cathode sections 411, 414 in electrolysis mode) may also be referred to as fuel electrode sections. The cathode sections 412, 415 in fuel cell mode (i.e., the anode sections 412, 415 in electrolysis mode) may also be referred to as air electrode sections.

In electrolysis mode, the first cathode section 411 of the first fuel cell stack 410 is configured to receive an input stream including water. An electrical current is applied causing the water to split into hydrogen and oxygen. The first cathode section 411 is configured to output a first output stream 524 including residual water and hydrogen. Oxygen crosses from the first cathode section 411 to the first anode section 412 and is output from the first anode section 412. In some embodiments, the first anode section 412 is configured to receive an inlet air stream to dilute the oxygen. The first anode section 412 may therefore output an exhaust stream 528 including the oxygen generated in the electrolysis reaction and the air from the inlet air stream.

The residual water and hydrogen output from the first cathode section 411 as the first output stream 524 may be output to the combining junction 422 and mixed with a recycle stream 529 from the second fuel cell stack 413, which may also include residual water and hydrogen. The combining junction 422 may output a mixed stream 526 including residual water and hydrogen from the first and second fuel cell stacks 410, 413. The mixed stream 526 may be output to a hydrogen separator, which may be or include the water knockout pot 460 or another hydrogen separator (e.g., a membrane separator). Rather than directing the hydrogen separated from the mixed stream 426 to the second fuel cell stack 413 and removing the water from the system (e.g., as in fuel cell mode), in electrolysis mode, the hydrogen is instead directed out of the system (e.g., to hydrogen storage, etc. via hydrogen stream 534), and the (hydrogen-depleted) mixed stream 526 is directed to the second fuel cell stack 413. In some embodiments, some hydrogen may remain mixed with the water (e.g., steam, water vapor, etc.) and may be directed to the second fuel cell stack 413 along with the water in the mixed stream 526.

The (hydrogen-depleted) mixed stream 526 may be pressurized by the recycle blower 430. If the water in the mixed stream 526 has been condensed, it may be heated and re-vaporized before being pressurized by the recycle blower 430. The pressurized mixed stream 526 may then be directed to the recuperator 440, where it may be further heated using heat from the recycle stream of the second fuel cell stack 413. The pressurized and heated mixed stream 526 may then be directed to the second cathode section 414 of the second fuel cell stack 413. The second fuel cell stack 413, operating as an electrolysis cell stack, receives the mixed stream 526 at the second cathode section 414. At least a portion of the water in the mixed stream 526 is separated into hydrogen, which is output by the second cathode section 414 as a second output stream 527, and oxygen, which mixes with the inlet air 525 and is output by the second anode section 415 as an exhaust stream 528. The inlet air stream received to dilutes the oxygen in the anode section 415. The exhaust stream 528 may be exhausted from the system or used elsewhere.

The second cathode section 414 may output the second output stream 527 including hydrogen isolated during the electrolysis reaction and residual water. The second output stream 527 may be directed to the separating junction 420, which may be configured to separate the second output stream 527 into a recycle stream 529 and an exhaust stream 531. The recycle stream 529 may be directed to the combining junction 422, where it may be mixed with the first output stream 524 from the first cathode section 411 and recycled back to the second cathode section 414. The exhaust stream 531 may be directed to a second hydrogen separator 462. The second hydrogen separator 462 may separate hydrogen from water in the exhaust stream 531, for example, using a membrane separator or by cooling the exhaust stream 531 such that the water condenses. The separated hydrogen may be removed from the system (e.g., via hydrogen stream 534) for use elsewhere or may be directed to hydrogen storage for later use. The hydrogen isolated by the hydrogen separators 460, 462 and stored in hydrogen storage may be used as fuel when the hybrid SOFC system 400 is operating as s fuel cell system. The hybrid SOFC system 400 may thus be a reversible fuel cell system that can generate hydrogen in electrolysis mode (e.g., when excess electricity is available), and can use the generated hydrogen as fuel to generate electricity in fuel cell mode (e.g., when additional electricity is needed).

A simulation model was created to compare the hybrid SOFC system 400 operating in electrolysis mode to conventional electrolysis systems, including a single-stack system with hydrogen separation only at the system outlet and a single-stack system with in-recycle hydrogen separation. Compared to the conventional systems, the hybrid SOFC system 400 operating in electrolysis mode had one of the lowest stack utilizations, and thus one of the highest efficiency. The hybrid SOFC system 400 operating in electrolysis mode also had the highest inlet and outlet steam concentrations, implying higher efficiency or the same efficiency with higher output hydrogen. The hybrid SOFC system 400 operating in electrolysis mode had relatively low stack flow rates for lower pressure drop, relatively low recycle flow allowing for smaller recycle blowers and pipe sizing, and relatively low flow into the hydrogen separators. A conventional system can achieve a similar stack utilization but would require twice the stack flow and five times the recycle flow, requiring a larger recuperator and recycle blower.

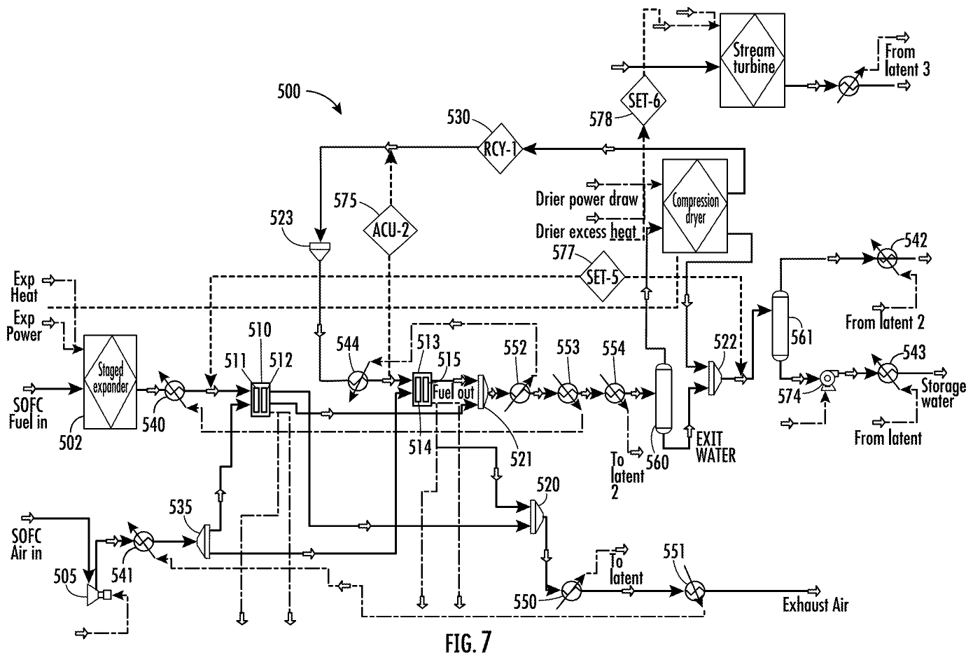

FIG. 7 depicts a simulation model of a hybrid SOFC system 500. The hybrid SOFC system 500 is an implementation of the hybrid SOFC system 400 shown in FIG. 5 and is configured for operation in fuel cell mode.

The hybrid SOFC system 500 includes a staged expander 502 configured to receive the input stream having the fuel, to reduce the pressure of the input stream, and to output the input stream to the first heater 540.

The hybrid SOFC system 500 includes a first heater 540 configured to receive the input stream, to heat the input stream, and to output the input stream to the first anode section 511 of the first fuel cell stack 510. The first heater 540 is configured to receive heat from the fourth cooler 553.

The hybrid SOFC system 500 includes a first compressor 505 configured to receive inlet air having oxygen, to pressurize the inlet air, and to output the inlet air to the second heater 541.

The hybrid SOFC system 500 includes a second heater 541 configured to receive the inlet air, to heat the inlet air, and to output the inlet air to the first splitter 535. The second heater 541 is configured to receive heat from the second cooler 551.

The hybrid SOFC system 500 includes a first splitter 535 configured to receive the inlet air, to split the inlet air into a first inlet air stream and a second inlet air stream, to output the first inlet air stream to the first cathode section 512 of the first fuel cell stack 510, and to output the second inlet air stream to the second cathode section 515 of the second fuel cell stack 513.

The hybrid SOFC system 500 includes a first fuel cell stack 510 having a first anode section 511 and a first cathode section 512. The first anode section 511 is configured to receive the input stream from the first heater 540. The first cathode section 512 is configured to receive the first inlet air stream. The first fuel cell stack 510 is configured to produce electricity when the first anode section 511 reacts with the fuel of the input stream and the first cathode section 512 reacts with oxygen of the first inlet air stream. The first anode section 511 of the first fuel cell stack 510 is configured to output a first output stream having residual fuel and water to the second mixer 521. The first cathode section 512 is configured to output a first exhaust air stream to the first mixer 520.

The hybrid SOFC system 500 includes a first mixer 520 configured to receive a first exhaust air stream from the first cathode section 512 of the first fuel cell stack 510 and to receive a second exhaust air stream from the second cathode section 515 of the second fuel cell stack 513. The first mixer 520 is configured to combine the first exhaust air stream and the second exhaust air stream, and to output a combined exhaust air stream to the first cooler 550.

The hybrid SOFC system 500 includes a first cooler 550 configured to receive the combined exhaust air stream from the first mixer 520, to cool the combined exhaust air stream, and to output the combined exhaust air stream to the second cooler 551. The first cooler 550 is configured to output heat to the fourth heater 543.

The hybrid SOFC system 500 includes a second cooler 551 configured to receive the combined exhaust air stream from the first cooler 550, to cool the combined exhaust air stream, and to output the combined exhaust air out of the hybrid SOFC system 500. The second cooler 551 is configured to output heat to the second heater 541.

The hybrid SOFC system 500 includes a second mixer 521 configured to receive a first output stream from the first anode section 511 of the first fuel cell stack 510 and to receive a second output stream from the second anode section 514 of the second fuel cell stack 513. The second mixer 521 is configured to combine the first output stream and the second output stream, and to output a combined output stream to the third cooler 552.

The hybrid SOFC system 500 includes a third cooler 552 configured to receive the combined output stream from the second mixer 521, to cool the combined output stream, and to output the combined output stream to the fourth cooler 553. The third cooler 552 is configured to output heat to the fifth heater 544.

The hybrid SOFC system 500 includes a fourth cooler 553 configured to receive the combined output stream from the third cooler 552, to cool the combined output stream, and to output the combined output stream to the fifth cooler 554. The fourth cooler 553 is configured to output heat to the first heater 540.

The hybrid SOFC system 500 includes a fifth cooler 554 configured to receive the combined output stream from the fourth cooler 553, to cool the combined output stream, and to output the combined output stream to the first water knockout pot 560. The fifth cooler 554 is configured to output heat to the third heater 542.

The hybrid SOFC system 500 includes a first water knockout pot 560 configured to receive the combined output stream from the fifth cooler 554, to remove water from the combined output stream and to output water to the third mixer 522, and to output the combined output stream to the compression dryer 572.

The hybrid SOFC system 500 includes a compression dryer 572 configured to receive the combined output stream from the first water knockout pot 560, to remove water from the combined output stream and to output water to the third mixer 522, and to output the combined output stream to the recycle blower 530.

The hybrid SOFC system 500 includes a third mixer 522 configured to receive water from the first water knockout pot 560 and to receive water from the compression dryer 572, and to output water to the second water knockout pot 561.

The hybrid SOFC system 500 includes a second water knockout pot 561 configured to receive water from the third mixer 522, to output a system exhaust stream to a third heater 542, and to output water to a pump 574.

The hybrid SOFC system 500 includes a third heater 542 configured to receive the third output stream from the second water knockout pot 561, to heat the third output stream, and to output the system exhaust stream. The third heater 542 is configured to receive heat from the fifth cooler 554.

The hybrid SOFC system 500 includes a pump 574 configured to receive water from the second water knockout pot 561, and to output water to the fourth heater 543.

The hybrid SOFC system 500 includes a fourth heater 543 configured to receive water from the pump 574, to heat the water, and to output the water for storage. The fourth heater 543 is configured to receive heat from the first cooler 550.

The hybrid SOFC system 500 includes a recycle blower 530 configured to receive the combined output stream from the compression dryer 572, to pressurize the combined output stream, and to output the combined output stream to the fourth mixer 523.

The hybrid SOFC system 500 includes a fourth mixer 523 configured to receive the combined output stream from the recycle blower 530, and to output the combined output stream to the fifth heater 544.

The hybrid SOFC system 500 includes a fifth heater 544 configured to receive the combined output stream from the fourth mixer 523, to heat the combined output stream, and to output the combined output stream to the second anode section 514 of the second fuel cell stack 513. The fifth heater 544 is configured to receive heat from the third cooler 552.

The hybrid SOFC system 500 includes a second fuel cell stack 513 having a second anode section 514 and a second cathode section 515. The second anode section 514 is configured to receive the combined output stream from the fifth heater 544. The second cathode section 515 is configured to receive the second inlet air stream. The second fuel cell stack 513 is configured to produce electricity when the second anode section 514 reacts with the fuel of the combined output stream and the second cathode section 515 reacts with oxygen of the second inlet air stream. The second anode section 514 of the second fuel cell stack 513 is configured to output a second output stream having residual fuel and water to the second mixer 521. The second cathode section 515 of the second fuel cell stack 513 is configured to output a second exhaust air stream to the first mixer 520.

The settings for the simulation model of the hybrid SOFC system 500 allow a user to adjust the amount of the combined output stream configured to be output by the recycle blower 530 to match the desired amount of the combined output stream configured to be received by the second anode section 514 of the second fuel cell stack 513.

The settings for the simulation model of the hybrid SOFC system 500 also allow the user to set the amount of water configured to be output by the third mixer 522 based on the amount of the input stream configured to be received by the first anode section 511 of the first fuel cell stack 510.

The settings for the simulation model of the hybrid SOFC system 500 also allow the user to set the amount of heat configured to be received by the steam turbine 570 based on the amount of the drier excess heat configured to be received by the compression dryer 572.

### Configuration of Example Embodiments

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Additionally, it should be understood that features from one embodiment disclosed herein may be combined with features of other embodiments disclosed herein as one of ordinary skill in the art would understand. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

What is claimed is:

1. A solid oxide fuel cell system comprising:
a first fuel cell stack comprising a first anode section and a first cathode section, the first anode section configured to receive an input stream comprising fuel and to output a first output stream comprising residual fuel and water, the first cathode section configured to receive inlet air and to output exhaust air;
a second fuel cell stack comprising a second anode section and a second cathode section, the second anode section configured to receive a mixed stream and to output a second output stream comprising residual fuel and water, the second cathode section configured to receive inlet air and to output exhaust air;
a separating junction configured to receive the second output stream and to separate the second output stream into a recycle stream and an exhaust stream; and
a combining junction configured to receive the first output stream and the recycle stream, and to combine the first output stream and the recycle stream to output the mixed stream.

2. The solid oxide fuel cell system of claim 1, further comprising a water knockout pot configured to remove water from the mixed stream.

3. The solid oxide fuel cell system of claim 1, further comprising a recycle blower configured to pressurize the mixed stream.

4. The solid oxide fuel cell system of claim 1, further comprising a recuperator configured to receive the recycle stream from the separating junction and to output the recycle stream to the combining junction, to receive the mixed stream from the combining junction and to output the mixed stream to the second anode section of the second fuel cell stack, and to transfer heat from the recycle stream to the mixed stream.

5. The solid oxide fuel cell system of claim 1, further comprising a combustor configured to receive the exhaust stream and the exhaust air from the first cathode section of the first fuel cell stack and the exhaust air from the second cathode section of the second fuel cell stack, and to combust the exhaust stream.

6. A solid oxide fuel cell system configured for operation as a solid oxide electrolysis cell system, the solid oxide fuel cell system comprising:
a first fuel cell stack comprising a first anode section and a first cathode section, the first cathode section configured to receive an input stream comprising water, and to output a first output stream comprising residual water and hydrogen, the first anode section configured to output exhaust air;
a second fuel cell stack comprising a second anode section and a second cathode section, the second cathode section configured to receive a mixed stream and to output a second output stream comprising residual water and hydrogen, the second anode section configured to output exhaust air;
a separating junction configured to receive the second output stream and to separate the second output stream into a recycle stream and an exhaust stream; and
a combining junction configured to receive the first output stream and the recycle stream, and to combine the first output stream and the recycle stream to output the mixed stream to the second cathode section.

7. The solid oxide fuel cell system of claim 6, further comprising a hydrogen separator configured to separate hydrogen from the mixed stream.

8. The solid oxide fuel cell system of claim 6, further comprising a recycle blower configured to pressurize the mixed stream.

9. The solid oxide fuel cell system of claim 6, further comprising a recuperator configured to receive the recycle stream from the separating junction and to output the recycle stream to the combining junction, to receive the mixed stream from the combining junction and to output the mixed stream to the second cathode section of the second fuel cell stack, and to transfer heat from the recycle stream to the mixed stream.

10. The solid oxide fuel cell system of claim 6, further comprising a hydrogen separator configured to receive the exhaust stream and to separate hydrogen from the exhaust stream.

11. A method of operating a solid oxide fuel cell system, the method comprising:
operating the solid oxide fuel cell system in fuel cell mode, comprising:
providing a first input stream comprising fuel to a first fuel electrode section of a first fuel cell stack;
directing a first output stream comprising residual fuel and water from the first fuel electrode section of the first fuel cell stack to a combining junction;
directing a first mixed stream from the combining junction to a second fuel electrode section of a second fuel cell stack;
directing a second output stream comprising residual fuel and water from the second fuel electrode section of the second fuel cell stack to a separating junction;
separating the second output stream into a first recycle stream and a first exhaust stream at the separating junction; and
combining the first recycle stream and the first output stream into the first mixed stream at the combining junction.

12. The method of claim 11, wherein operating the solid oxide fuel cell system in fuel cell mode further comprises removing water from the first mixed stream before directing the first mixed stream to the second fuel electrode section.

13. The method of claim 12, wherein operating the solid oxide fuel cell system in fuel cell mode further comprises pressurizing the first mixed stream after removing the water from the first mixed stream.

14. The method of claim 11, wherein operating the solid oxide fuel cell system in fuel cell mode further comprises transferring heat from the first recycle stream to the first mixed stream.

15. The method of claim 11, wherein operating the solid oxide fuel cell system in fuel cell mode further comprises combusting the first exhaust stream using air from air electrode sections of the first fuel cell stack and the second fuel cell stack.

16. The method of claim 11 further comprising:
operating the solid oxide fuel cell system in electrolysis mode, comprising:
providing a second input stream comprising water to the first fuel electrode section;
providing an electrical current to the first fuel cell stack to electrolyze the water in the first fuel electrode section;
directing a third output stream comprising residual water and hydrogen from the first fuel electrode section to the combining junction;
directing a second mixed stream from the combining junction to the second fuel electrode section;
providing an electrical current to the second fuel cell stack to electrolyze the water in the second fuel electrode section;
directing a fourth output stream comprising residual water and hydrogen from the second fuel electrode section to the separating junction;
separating the fourth output stream into a second recycle stream and a second exhaust stream at the separating junction; and
combining the second recycle stream and the third output stream into the second mixed stream at the combining junction.

17. The method of claim 16, wherein operating the solid oxide fuel cell system in electrolysis mode further comprises removing hydrogen from the second mixed stream before directing the second mixed stream to the second fuel electrode section.

18. The method of claim 17, wherein operating the solid oxide fuel cell system in electrolysis mode further comprises pressurizing the second mixed stream after removing the hydrogen from the second mixed stream.

19. The method of claim 16, wherein operating the solid oxide fuel cell system in electrolysis mode further comprises transferring heat from the second recycle stream to the second mixed stream.

20. The method of claim 16, wherein operating the solid oxide fuel cell system in electrolysis mode further comprises separating hydrogen from the second exhaust stream.
